(19) United States
(12) Patent Application Publication
(10) Pub. No.: US 2016/0343030 A1
(43) Pub. Date: Nov. 24, 2016

(54) MITIGATING AT LEAST SOME EFFECTS OF COOKIE CHURN

(71) Applicant: YAHOO! INC., Snnyvale, CA (US)

(72) Inventors: Xiaohang Qu, Beijing (CN); Choon Kit Chan, (US); Lixing Bo, Beijing (CN)

(21) Appl. No.: 14/759,121

(22) PCT Filed: Dec. 31, 2014
(86) PCT No.: PCT/CN2014/095877

§ 371 Date: Jul. 2, 2015

(51) Int. Cl. G06Q 30/02

(52) U.S. Cl. CPC G06Q 30/0255; G06Q 30/0275

(57) ABSTRACT

Briefly, for an embodiment, as an example, a method may include recovering one or more cookies for a particular user based at least in part on one or more cookie maps.

### BACKGROUND

1. Field

The present disclosure relates generally to mitigating at least some effects of browser cookie churn, which may include, for example, replacement of browser cookie(s)

2. Information

At times, Internet advertisers may be seeking users who may be interested in viewing a particular advertisement and, hopefully, purchasing an advertised product and/or service, for example. To increase likelihood that a particular advertisement may be relevant to an Internet user, an advertiser may seek to discover attributes of Internet users. For example, an Internet advertiser seeking potential buyers of running shoes may benefit from discovering a particular Internet user has recently accessed an article pertaining to distance running and/or recently purchased a product related, for example, to outdoor running attire. Accordingly, it may be desirable for the individual, as well as the advertiser, for example, for an advertisement to be displayed to the particular user featuring high-performance running shoes and/or coupons for obtaining related equipment at a discount price.

A typical advertising service model may utilize browser cookies to provide insight into interests, browsing behaviors, shopping habits, and/or other attributes of Internet users. A browser cookie may, for example, provide an indication of recent purchases, which may be utilized to assess related products and/or services that may be of potential interest to an Internet user. However, from time to time, browser cookies may be intentionally or unintentionally deleted from an Internet user's cookie cache, for example, or may not be readily available for other reasons. Consequently, an Internet user may receive irrelevant advertisements that the Internet user may have little interest in viewing. This may represent not only a misdirection of Internet advertising resources, but may also represent a source of frustration for an Internet user who may, at least on occasion, feel inundated with uninteresting advertising content.

### BRIEF DESCRIPTION OF DRAWINGS

Claimed subject matter is particularly pointed and/or distinctly claimed in the concluding portion of the specification. However, both as to organization and/or method of operation, together with objects, features, and/or advantages thereof, claimed subject matter may be understood by reference to the following detailed description if read with the accompanying drawings in which:

FIG. 1 is a schematic diagram of an online advertising environment utilizing a real-time bidding system according to an embodiment;

FIG. 2 is a table illustrating correspondence of events in an execution flow for a method of mitigating at least some effects of cookie churn according to an embodiment;

FIG. 3 is a schematic diagram showing multiple cookie maps and cookie mapping to a master key according to an embodiment; and

FIG. 4 is a schematic diagram of a computing platform that may be employed in mitigating at least some effects of cookie churn according to an embodiment.

Reference is made in the following detailed description of the accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and/or similar terms are to be associated with appropriate physical quantities and are intended to merely be convenient labels.

Likewise, in this context, the terms “coupled,” “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and,” “or,” “and/or,” and/or similar terms, as used herein, include a variety of meanings that also are expected to depend at least in part upon the particular context in which such terms are used. Typically, “or” if used to associate a list, such as A, B, or C, is intended to mean A, B, and C, here used in the inclusive sense, as well as A, B, or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets), such as via a wired or wireless network, they may also be capable of performing arithmetic and/or logic operations, processing and/or storing signals, such as in memory as non-transitory physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof. Signal packets, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices or one or more server devices, as appropriate. Along similar lines, references to a “database” are understood to mean, one or more databases and/or portions thereof, as appropriate. It should be understood that for ease of description, a network device may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of computer and/or machine readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent.

Likewise, sub-networks, such as may employ differing architectures and/or may be compliant and/or compatible with differing protocols, such as computing and/or communication protocols (e.g., network protocols), may interoperate within a larger network. In this context, the term sub-network refers to a portion and/or part of a network. Sub-networks may also comprise links, such as physical links, connecting and/or coupling nodes to transmit signal packets and/or frames between devices of particular nodes including wired links, wireless links, or combinations thereof. Various types of devices, such as network devices and/or computing devices, may be made available so that device interoperability is enabled and/or, in at least some instances, may be transparent to the devices.

In this context, the term “transparent” refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs.

In this context, a private network refers to a particular, limited set of network devices able to communicate with other network devices in the particular, limited set, such as via signal packet and/or frame transmissions, for example, without a need for re-routing and/or redirecting network communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate noes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but such devices outside the private network may not necessarily direct inbound network communications to devices included in the private network.

Physically connecting portions of a network via a hardware bridge, as one example, may be done, although other approaches also exist. A hardware bridge, however, may not typically include a capability of interoperability via higher levels of a network protocol. A network protocol refers to a set of signaling conventions for communications between and/or among devices in a network, typically network devices, but may include computing devices, as previously discussed; for example, devices that substantially comply with the protocol and/or that are substantially compatible with the protocol.

Typically, a network protocol has several layers. These layers may be referred to here as a network stack. Various types of network transmissions may occur across various layers. For example, as one moves higher in a network stack, additional operations may be available by initiating network transmissions that are compatible and/or compliant with a particular network protocol at these higher layers. Therefore, for example, a hardware bridge may be unable to forward signal packets since it may operate at a layer of a network stack that does not provide that capability. Although higher layers of a network protocol may, for example, affect device permissions, user permissions, etc., a hardware bridge, for example, may typically provide little user control, such as for higher layer operations.

The Internet refers to a decentralized global network of interoperable networks that comply with the Internet Protocol (IP). It is noted that there are several versions of the Internet Protocol. Here, the term Internet Protocol or IP is intended to refer to any version, now known and/or later developed. The Internet includes local area networks (LANs), wide area networks (WANs), wireless networks, and/or long haul public networks that, for example, may allow signal packets and/or frames to be communicated between LANs. The term world wide web (WWW or web) and/or similar terms may also be used, although it refers to a sub-portion of the Internet that complies with the Hypertext Transfer Protocol or HTTP. For example, network devices may engage in an HTTP session through an exchange of Internet signal packets and/or frames. It is noted that there are several versions of the Hypertext Transfer Protocol. Here, the term Hypertext Transfer Protocol or HTTP is intended to refer to any version, now known and/or later developed. It is likewise noted that in various places in this document substitution of the term Internet with the term World Wide Web and may be made without a significant departure in meaning and may, therefore, not be inappropriate in that the statement would remain correct with such a substitution.

Although claimed subject matter is not limited in scope to the Internet or to the web, it may, without limitation, provide a useful example of an embodiment for purposes of illustration. As indicated, the Internet may comprise a worldwide system of interoperable networks, including devices within those networks. The Internet has evolved to a public, self-sustaining facility that may be accessible to hundreds of millions of people or more worldwide. Also, in an embodiment, and as mentioned above, the terms “WWW” and/or “web” refer to a sub-portion of the Internet that complies with the Hypertext Transfer Protocol or HTTP. The web, therefore, in this context, may comprise an Internet service that organizes stored content, such as, for example, text, images, video, etc., through the use of hypermedia, for example. A hypertext markup language (“HTML”), for example, may be utilized to specify content and/or format of hypermedia type content, such as in the form of a file or an “electronic document,” such as a web page, for example. An Extensible Markup Language (“XML”) may also be utilized to specify content and/or format of hypermedia type content, such as in the form of a file or an “electronic document,” such as a web page, in an embodiment. Of course, HTML and XML are merely example languages provided as illustrations and, furthermore, HTML and/or XML is intended to refer to any version, now known and/or later developed. Likewise, claimed subject matter is not intended to be limited to examples provided as illustrations, of course.

The term “website” and/or similar terms refer to a collection of related web pages, in an embodiment. The term “web page” and/or similar terms relates to any electronic file and/or electronic document, such as may be accessible via a network, by specifying a uniform resource locator (URL) for accessibility via the web, in an example embodiment. As alluded to above, a web page may comprise content coded using one or more languages, such as, for example, HTML and/or XML, in one or more embodiments. Although claimed subject matter is not limited in scope in this respect. Also, in one or more embodiments, developers may write code in the form of JavaScript, for example, to provide content to populate one or more templates, such as for an application. Here, JavaScript is intended to refer to any now known or future versions. However, JavaScript is merely an example programming language. As was mentioned, claimed subject matter is not limited to examples or illustrations.

Terms including “entry,” “electronic entry,” “document,” “electronic document,” “content,” “digital content,” “item,” and/or similar terms are meant to refer to signals and/or states in a format, such as a digital format, that is perceivable by a user, such as if displayed and/or otherwise played by a device, such as a digital device, including, for example, a computing device. In an embodiment, “content” may comprise one or more signals and/or states to represent physical measurements, such as may be generated by sensors, for example. For one or more embodiments, an electronic document may comprise a web page coded in a markup language, such as, for example, HTML (hypertext markup language). In another embodiment, an electronic document may comprise a portion and/or a region of a web page. However, claimed subject matter is not limited in these respects. Also, for one or more embodiments, an electronic document and/or electronic entry may comprise a number of components. Components in one or more embodiments may comprise text, for example, in the form of physical signals and/or states, such as may be shown on a display, for example. Also for one or more embodiments, components may comprise a graphical object, such as, for example, an image, such as a digital image, and/or sub-objects, such as attributes thereof. In an embodiment, digital content may comprise, for example, digital images, digital audio, digital video, and/or other types of electronic documents.

Signal packets and/or frames, also referred to as signal packet transmissions and/or signal frame transmissions, may be communicated between nodes of a network, where a node may comprise one or more network devices and/or one or more computing devices, for example. As an illustrative example, but without limitation, a node may comprise one or more sites employing a local network address. Likewise, a device, such as a network device and/or a computing device, may be associated with that node. A signal packet and/or frame may, for example, be communicated via a communication channel and/or a communication path comprising a portion of the Internet, or from a site via an access node coupled to the Internet. Likewise, a signal packet and/or frame may be forwarded via network nodes to a target site coupled to a local network, for example. A signal packet and/or frame communicated via the Internet, for example, may be routed via a path comprising one or more gateways, servers, etc. that may, for example, route a signal packet and/or frame in accordance with a target and/or destination address and availability of a network path of network nodes to the target and/or destination address. Although the Internet comprises a network of interoperable networks, not all of those interoperable networks are necessarily available and/or accessible to the public.

As the term may be used herein, a client device, such as a client computing device, may receive, store, and/or transmit one or more “cookies” that may comprise an identifier to identify a user of a client device, for example, to one or more servers with which the client device may communicate, in an embodiment. In this context, a cookie refers to any mechanism employing physical signals and/or states,such as memory states, employed to identify a particular user and/or an account of a particular user. Thus, as a non-limiting example, a cookie may, for example, comprise any combination of binary digital signals, such as electronic transmissions, and/or physical states, such as memory states. A cookie may, in an embodiment, not necessarily be unique by itself; however, terms, such as“user cookie,” or simply “cookie,” in this context may include several parameters and/or identifiers that, if taken together, may be employed to correspond with a particular user and/or a particular user account, such as, for example, in connection with an Internet service, as an example. In one possible example, a particular client device user utilizing three client devices (e.g., laptop, tablet, and smart phone) may obtain three separate cookies corresponding to client devices. In another possible example, a particular client device user utilizing two or more separate client accounts executing on a processor of a laptop may, for example, obtain two or more separate cookies corresponding to the separate client accounts. In a further possible example, two or more client device users utilizing a single client account may obtain, for example, a single cookie, which corresponds to the single client account.

In particular embodiments, again, as a non-limiting illustrative example, a cookie and/or other set of parameters, may be transmitted by a server to a browser and may be returned by the browser as a result of subsequent server access, for example. In particular embodiments, a cookie may be used to identify an Internet user, for example, and/or track an Internet user's access to one or more servers, for example. Thus, a cookie is contemplated as comprising any number of possible approaches toward identifying users, such as of a network, and/or other entities, and claimed subject matter is not intended to be limited to any particular approach. Further, as the term is used herein, a “query,” or “submitting a query,” and/or similar terms, refers to making a request for content electronically, including descriptive content, such via an electronic communication, but is otherwise not intended to be limited to a particular format or approach. Thus, a query is not limited to use of an application program interface (API), for example.

Media networks, such as the Yahoo!™ network, for example, may be increasingly seeking ways to attract users to its networks and/or to retain users within its networks for extended periods of time. A media network may, for example, comprise an Internet website and/or group of websites having one or more sections.

For instance, the Yahoo!™ network may comprise websites located within different categorized sections, such as sports, finance, current events, and games, to name just a few non-limiting examples among a variety of possible examples. To attract and/or retain users within its network, Yahoo!™ and/or other media networks may continually strive to provide content relating to categorized sections that may be interesting and/or of use to users.

As users remain within a media network, a media network may discover aspects relating to interactions by users within its media network, for example. For example, particular news items and/or articles displayed to users, particular search queries formulated by a user, particular items and/or services from a shopping website recently visited by a user, and so forth, may be discovered. Although claimed subject matter is not intended to limited to these illustrative examples.

To discover a user's Internet browsing, shopping, and/or purchasing behaviors, a network may utilize a cookie to associate certain behaviors and/or interests with a particular Internet user and/or group of users utilizing a client device, for example. A user, such as an Internet user, may also benefit from a media network discovering the user's interests, behaviors, shopping habits, and so forth. For example, if an Internet user were to be identified as being likely to have an interest in particular types of sports equipment, an advertiser of the particular type of sports equipment may be willing to pay a premium to display an advertisement to the Internet user, for example. Likewise, the Internet user may desirably be presented with advertisements, coupons, special offers, advertiser-sponsored activities, and so forth, since the user may have a particular interest. Further, the user may be spared what may sometimes appear to be an onslaught of advertising content with which the user may have little interest and/or which may have little influence on the user's purchasing decision. Further, such irrelevant advertising content may represent less efficient use of media network resources, such as computational resources, network bandwidth, and so forth.

However, at times, one or more cookies may be unobtainable by a media network, for example. In an embodiment, one or more cookies, such as may be stored in a cookie folder, for example, may be periodically and/or occasionally modified, or may otherwise experience “churn.” In this context, “cookie churn” and/or similar terms refer to making an existing cookie unusable for tracking a particular user's browser actions and/or online interactions. Examples may comprise deletion of one or more cookies, replacement one or more cookies with new cookies, and/or any modification that may render one or more cookies unusable, for example. In some cases, churn of one or more cookies, such as of a cookie folder, may be responsive to one or more user interactions, such as a user-initiated erasure of a cookie folder. In other cases, churn of one or more cookies may be responsive to a relatively autonomous, user device-initiated process, such as a disk cleanup and/or detection of a cookie cache overflow, as examples. In still other cases, cookie churn may be brought about by associating a cookie with an expiration time and/or expiration date, which may give rise to deletion of one or cookies, for example. In other cases, cookie churn may be brought about by a client browser limiting a number of cookies that may correspond to a particular Internet domain. It should be noted that cookie churn may occur in response to a variety of other processes, and claimed subject matter is intended to not be limited to particular circumstances that may produce “cookie churn.”

If a media network, such as media network “A,” is unable to obtain one or more cookies and/or one or more cookies obtained convey an insufficient number of parameters of a corresponding user, an ability for media network “A” to distinguish among users may become at least partially impaired. Consequently, in some cases, even though media network “A,” may have compiled a relatively extensive database of cookies and/or other attributes of corresponding users, for example, media network “A” may find itself at a competitive disadvantage relative to media networks “B,” “C,” and “D,” for example. Accordingly, users of media network “A” as well may be unable to benefit from more accurate and/or better targeted advertising that may have otherwise been made possible. In this context, the term “supply-side platform” and/or similar terms refer to a platform to generate supply, here, a system operated by a media network in which the system is capable of generating advertising for display to one or more users, for example. Of course, a supply-side platform may comprise multiple systems. Thus, in a possible example, a “supply-side platform,” which may refer to a supplier of online advertisements, may offer an “impression,” which may refer to an opportunity for a client device user to view an advertisement, to one or more of media networks “A,” “B,” or “C,” for example. An offer from a supply-side platform may include a cookie, which may correspond to a cookie from media network “B,” for example. Accordingly, media network “A,” for example, may benefit from a mapping of cookies generated by media network “B” with cookies generated by media network “A,” prior to generating a response to an offer from a supply-side platform. In another example, an online clearinghouse may permit advertisers to ‘shop’ their advertisements to multiple media networks. Participating media networks, for example, may submit bids regarding prices (e.g., charges) to display advertisements for advertisers to particular online users.

Thus, an inability to obtain one or more cookies that adequately conveys user online activity, for example, may hinder media network “A” from accurately estimating a bid for submission in connection with displaying one or more advertisements, for example. Hence, a “demand-side” platform, such as media network “A,” may submit bids to display advertisements via a “supply-side” platform, such as an online advertising clearinghouse, for example. In some instances, media network “A” may be unlikely to be selected to display an advertisement responsive to inadequate and/or incomplete tracking from cookie churn, which may influence a bid proffered by media network “A.” In this context, the term “demand-side platform” and/or similar terms refer to a platform to generate demand for advertisements, here, a system operated by a media network, such as, for example, media networks “A,” “B,” “C,” and “D.”As an example, a demand-side platform may comprise a client computing system, for example. Of course, a demand-side platform may likewise comprise multiple systems. Thus, in certain embodiments, together, a group of demand-side platform may operate as a clearinghouse, which may comprise a real-time bidding system, for example, to receive bids from media networks, such as media networks “A,” “B,” “C,” and “D,” for example. As mentioned, media network “A” may find itself at a competitive disadvantage relative to media networks “B,”“C,” and “D,” for example, in at least some situations. Accordingly, as also mentioned, users of media network “A” maybe unable to benefit from more accurate and/or better targeted advertising that may have otherwise been made possible.

In particular embodiments, a bidding portion and a cookie mapping portion may comprise two or more different types of interactions between a “demand-side” platform, such as a media network, and a “supply-side” platform, such as an online advertising clearinghouse, for example. A cookie mapping may be initiated, for example, if a user “a” visits a page of media network “A,” in which, media network “A” may assign, for example a cookie comprising a value “Y.” In an embodiment, media network “A” may initiate a cookie mapping request to a supply-side platform, with a request, for example, to assign a cookie value corresponding to the cookie assigned by the supply-side platform. In one possible example, a supply-side platform may assign a cookie having a demand-side value “Y” with a supply-side value of, for example, “12.” Accordingly, at least a temporary equivalence may be established between cookie value “12,” assigned by a supply-side platform (e.g., an online advertising clearinghouse) and cookie value “Y,” which may be assigned by a demand-side platform(e.g., media network “A”). In some embodiments, media network “A” may create and/or maintain a mapping, in which “Y_{demand-side}”=“12_{supply-side},” for example.

Accordingly, in a possible embodiment, bidding with respect to impressions may operate beginning with, for example, a supply-side platform offering an impression request with a cookie value to one or more of media networks A, B, C, or D. Responsive to receipt for an impression request, one or more of media networks A, B, C, or D may generate a bid based, at least in part, on a number of parameters and/or characteristics that a media network recognizes with respect to a user corresponding to a cookie value. In a particular instance, if media network “A” receives a request from supply-side with cookie “12,” for example, media network A may detect that a cookie comprising a “12” is at least temporarily equivalent to “Y” in media network “A.” Accordingly, media network “A” may generate and/or provide a bid for an impression for display to a user corresponding to cookie value “Y” based at least in part on the media network's record of the user's behavior.

In an embodiment, such as shown in Diagram 1, below, if a demand-side platform, such as media network “A,” initiates a cookie mapping to supply-side platform “B,” such as of a value “aa,” for example, media network “A” may determine that a value “aa” may be temporarily equivalent to “11” on supply-side platform. If, such as after a period of time elapses, cookie value “aa” is churned on media network “A,” but has not churned on supply-side platform “B,” media network A may initiate a new (e.g., another) cookie value “bb” mapping to supply-side platform “B.” Responsive thereto, media network “A” may determine that cookie value “bb” corresponds to cookie value “11” on supply-side platform “B,” for example. Likewise, a media network may establish at least temporary equivalence for cookie value “c with, for example, a cookie value of “11.”

Thus, in particular embodiments, if a supply-side platform transmits a bid request with cookie value “11,” for example, media network “A” may search for a stored online transactional history that refers to cookie value “bb,”’ which may correspond to a newly-matched cookie. However, for the example at hand, cookie values at least temporarily equivalent to cookie value “11” on a supply-side platform, may be, for example: aa=bb=cc=11. Accordingly, cookie values aa, bb, and cc may be aggregated, which may provide a more comprehensive and/or potentially valuable online transactional history than stand-alone cookies “aa,” “bb,” and “cc,” for example.

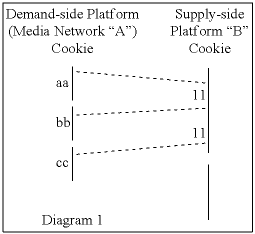

If there is more than one supply-side platform, media network “A” may, for example, double confirm and combine cookies together. As shown in Diagram 2, below, cookie value “aa” may be temporarily equivalent to cookie value “II” in supply-side platform “C.” in Diagram 2, at least temporary equivalence may be established among cookie values “aa,” “bb,” “11,” and ““II,” for example.

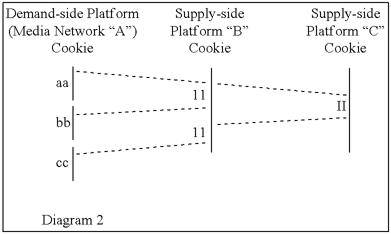

Embodiments of claimed subject matter may be utilized to mitigate at least some effects of cookie churn, as well as potentially providing additional benefits, although claimed subject matter is not limited in scope in this regard. In some embodiments, one or more processors may generate and/or process a cookie map, which may indicate correspondence among cookies generated and/or provided by multiple Internet domains and/or demand-side platforms, for example. In this context, the term “cookie map” and/or similar terms refer to an electronic document providing correspondence among cookies generated and/or provided by multiple Internet domains (e.g., websites and/or web pages). For example, as explained in more detail, one or more cookie maps may be generated by querying one or more demand-side platforms with respect to existing cookies. Thus, in an embodiment, one or more demand-side platforms may be employed to recover a cookie, as described below. In this context, the term “demand-side platform” and/or similar terms refer to a platform to generate demand for advertisements, here, a system operated by a media network, such as, for example, media networks “A,” “B,” “C,” and “D.”As an example, a demand-side platform may comprise a client computing system, for example. Of course, a demand-side platform may likewise comprise multiple systems. As mentioned previously, a group of demand side platforms together may operate as a clearinghouse, such as for a real-time bidding system.

Thus, despite cookie churn, a cookie map may provide a capability to recover a cookie provided and/or generated by a first media network using one or more cookies provided and/or generated by a second media network, for example, again, as described below, using an illustrative example. Thus, a media network may be capable of accessing detailed online browsing behaviors of corresponding users, which may thus permit a media network to, for example, more accurately estimate a bid for displaying one or more advertisements to be viewed by those users. In turn, users of media networks may likewise benefit from more accurately targeted advertising, for example.

In an embodiment, a computing device, which may include one or more processors, may receive a cookie of a first media network that may correspond to a cookie that has been churned (e.g., rendered unusable). Thus, one or more processors of the device may perform processing to determine if the received cookie nonetheless corresponds to a cookie of a second media network. If the one or more processors is able to determine correspondence between or among the cookie received by the first media network and a cookie of the second media network, one or more processors of the device of the first media network may employ a process to recover an otherwise churned cookie, so to speak. In embodiments, for example, a media network, such as the first media network in the immediately previous example, may access one or more databases which may, for example, comprise user identifications and/or cookies that may link to, for example, a user identifier. In an embodiment, therefore, a media network may generate a cookie map for relating one or more cookies to a plurality of cookies from individual domains which may, for example, correspond to a user identifier. In an embodiment, a user identifier may correspond, for example, to a user's electronic-mail address (e.g., user_1@media_network_A), although claimed subject matter is intended to embrace all forms of user identification, such as a cellular telephone number, as merely a non-limiting example.

In certain embodiments, if a plurality of cookie maps indicates multiple cookies that appear to correspond to a single user, for example, a master key for use with a master key/value pair may be employed. A master key and/or similar terms in this context refers to an identifier, such as a string, to associate different cookie maps of corresponding cookies and/or different, but corresponding, cookies on different cookie maps, such as may be generated by and/or derived from different demand-side platforms. A master key and/or similar terms may additionally refer to an identifier, such as a string, to associate different cookie maps between supply-side platform(s) and a demand-side platform(s). In an embodiment, a key portion of a key/value pair may remain relatively unchanged across a plurality of cookie maps being associated. In contrast, at least in particular embodiments, a value portion of a key/value pair may change to designate different, separate cookies being associated on different separate, cookie maps and/or different, separate cookie maps of corresponding, but different cookies, for a plurality of cookie maps being associated. In embodiments, a key portion of a key/value pair make comprise a first portion of an alphanumeric string, and a value portion of a key/value pair may comprise a second portion of an alphanumeric string, although claimed subject matter is not intended to be limited in scope in this respect. Rather, any identifier may be employed as a master key.

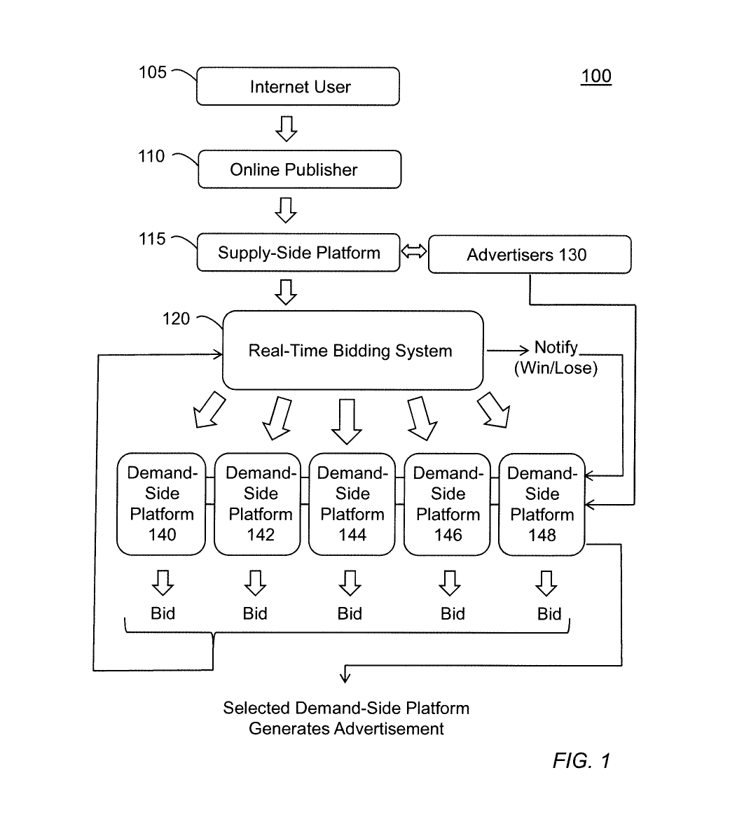

FIG. 1 is a schematic diagram of a real-time bidding system according to an embodiment 100. In an embodiment, such as 100 shown in FIG. 1, a user, such as 105 shown in FIG. 1, may comprise any number of users, such as Internet users, which may number into the thousands, millions, or billions, or more, almost virtually without limitation. User 105 may interact with (e.g., “browse”) electronic documents made available, for example, by an online publisher, such as 110 as shown in FIG. 1. Accordingly, online publisher 110 may, as examples, comprise an electronic-mail provider, an online forum, and/or an online retailer, which may include any website and/or web page available using the Internet. Of course, these are merely illustrations and claimed subject matter is not intended to be limited to illustrative examples.

In some embodiments, user 105 may operate a client device, which may comprise one or more processors, memory arrays, memory controllers, graphical user interfaces, and so forth, and which may operate in a manner to permit interaction with online publisher 110. It should be pointed out that although user 105 may comprise an “Internet” user, user 105 may also or alternatively interact with corporate intranets, and/or virtual private networks, which may include any type of wired or wireless network. Of course, again, these are merely illustrations and claimed subject matter is not intended to be limited to illustrative examples.

In an embodiment, such as shown in FIG. 1, online publisher 110 may be at least partially supported by revenue derived from advertising, which may be provided, for example, by one or more of advertisers 130. Online publisher 110 may utilize one or more cookies in connection with online interactions involving user 105, which may permit online publisher 110 to provide better targeted advertisements from advertisers 130 to user 105, for example. As previously mentioned, better targeted advertising may bring about a more efficient use of resources by providing an opportunity more likely to be of interest to user 105 to purchase goods and/or services, for example.

In an embodiment, such as shown in FIG. 1, if an opportunity arises for online publisher 110 to display an advertisement to user 105, online publisher 110 may notify supply-side platform 115 of an opportunity to supply an advertisement for presentation to user 105, for example. In this context, the term “supply-side platform” and/or similar terms refer to a platform to generate supply, here, a system operated by a media network in which the system is capable of generating advertising for display to one or more users, for example. Of course, a supply-side platform may comprise multiple systems. As an example, a supply-side platform may comprise one or more server computing systems, for example. In an embodiment, online publisher 110 may obtain a cookie transmitted by a browser operating on a client device utilized by user 105. In an embodiment, a cookie may be accompanied by additional parameters, which may specify details, for example, of an advertising impression to be presented to user 105. Additional advertising impression parameters may comprise, for example, page environment, URL, contextual category, browsing history, time zone, location, and so forth. In this context, the term “impression” and/or similar terms refer to a measure of the number of times an ad is seen. Thus, in general, clicking (or not clicking) is not taken into account. Of course, claimed subject matter is not intended to be limited to this illustrative example. It nonetheless is noted that online publisher 110 may transmit cookie parameters and any number of advertising impression parameters in an embodiment.

A real-time bidding (RTB) system, such as 120 shown in FIG. 1, may operate in a manner so as to comprise a real-time bidding auction. For example, in an embodiment, one or more cookies and/or advertising impression parameters may be transmitted to demand-side platforms 140, 142, 144, 146, and/or 148, for example. In some embodiments, a demand-side platform, such as 140-148, as examples, may comprise, a system for a media network, such as, for example, the Yahoo™ media network. Thus, one or more demand-side platforms 140-148 may estimate a bid to place an advertisement for display to user 105 by way of online publisher 110.

As a non-limiting example, one or more cookies corresponding to user 105 may indicate that user 105 may be a valuable customer (e.g., a reputable customer who routinely engages in online purchases of premium products and/or services from one or more online retailers).Accordingly, in at least some embodiments, if a demand-side platform is capable of ascertaining a number of attributes of user 105, the demand-side platform may offer a higher bid to a supply-side platform. Thus, one may expect one or more of demand-side platforms 140-148 to estimate a competitive and/or attractive bid, such as a bid that may include a premium for displaying an advertisement to user 105. On the other hand, if one or more cookies from user 105 indicates that user 105 may represent a less-valued customer, such as a customer with few online interactions, for example, one or more of demand-side platforms 140-148 may estimate a less attractive and/or competitive bid. Of course, this example is merely an illustration. Claimed subject matter is not intended to be limited in scope in this respect.

As previously mentioned, one or more cookies provided by a client device operated by user 105 may occasionally undergo churn, which may result, for example, in a cookie being purged from a cookie folder, for example. Consequently, at times, although user 105 may correspond to a valuable customer, again, as a non-limiting example, one or more cookies received from a client device operated by user 105 may not necessarily be recognized by one or more of demand-side platforms 140-148, for example. Thus, one or more of demand-side platforms 140-148, as a result of not recognizing the one or more received cookies, may estimate a less attractive and/or less competitive bid.

Thus, continuing with this non-limiting, illustrative example, if demand-side platform 140, as a specific example, is unable to recognize the one or more received cookies, it may estimate a less attractive and/or less competitive bid. As a result, system 120 may not select demand-side platform 140 to prepare an advertisement for display to user 105. Instead, system 140 may select another more attractive and/or more competitive bid that was submitted. The submitting demand-side platform is then notified regarding being selected to prepare an advertisement for display. The one or more of demand-side platforms 140-148 that were not selected may also be notified of not being selected. The selected demand-side platform among demand-side platforms of 140-148 may therefore generate/publish an advertisement for display to user 105.

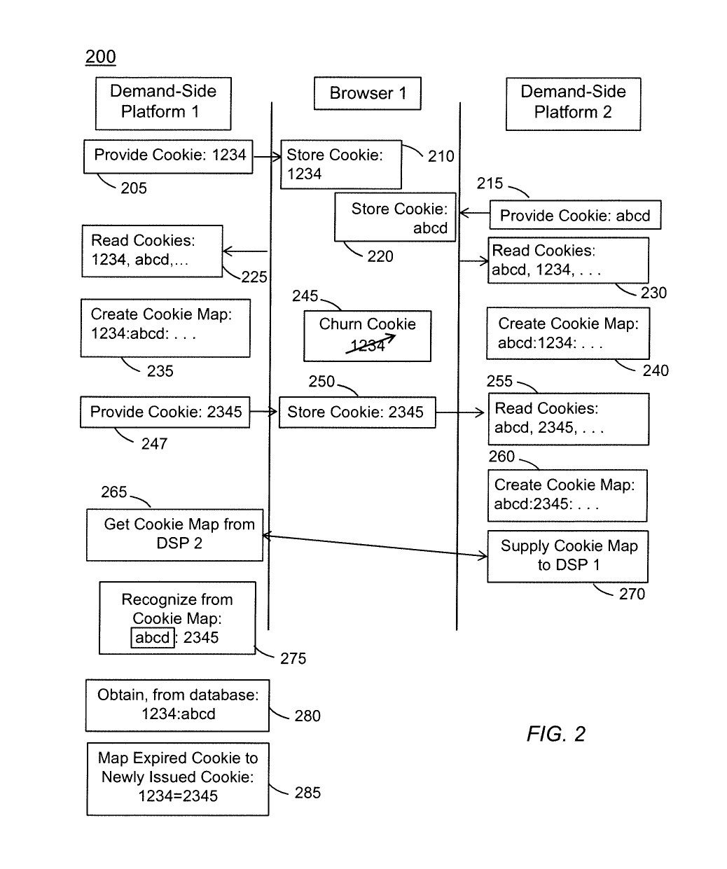

FIG. 2 is a table showing a correspondence of events in an execution flow for a method embodiment 200 of mitigating at least some effects of cookie churn. It is noted that alternate embodiments may include more or fewer blocks. Likewise, an alternate embodiment may include blocks in an alternate order. In particular embodiments, demand-side platforms 1 and 2 may comprise systems of respective media networks who, in general, compete with one another to provide users with relevant advertisements. Nonetheless, in connection with RTB, at least partially, since, in general, consumers benefit from RTB, some limited exchanges between, for example, platforms 1 and 2 in support thereof is permissible. In an embodiment, such as shown in FIG. 2, one or more of demand-side platforms 1 and 2 may be capable of recognizing its own cookies as well as cookies generated and/or provided by one or more other demand-side platforms (e.g., associated with and/or part of another media network). Demand-side platforms 1 and 2 may compare received cookies, which may be stored as physical states in one or more memory devices in an embodiment. For example, cookies generated and/or provided by demand-side platform 1 may, at least in one possible example, comprise an alphanumeric string of whole number values, such as “1234”. In another example, demand-side platform 2 may generate and/or provide cookies comprising an alphanumeric string of alphabetical characters, such as “abcd.” A method embodiment, such as shown in FIG. 2, may involve demand-side platforms, such as one or more of demand-side platforms 140-148 previously described with reference to FIG. 1. However, any computing and/or networking device, such as other platforms comprising a mix of one or more processors, including instructions to at least partially affect operations of one or more processors, may be utilized.

A method embodiment, such as shown in FIG. 2, may begin at block 205, in which a first demand-side platform (e.g., demand-side platform 1) may provide (e.g., generate and transmit) a cookie to a browser 1, for example. Demand-side platform 1 may generate and/or provide one or more cookies, such as a cookie comprising signal samples having values of, for example, “1234”. At 210, browser 1 may receive the one or more cookies, which may be stored on a computing device executing browser 1, for example. Demand-side platform 1 may generate and/or provide one or more cookies responsive to, for example, a user, such as an Internet user, operating browser 1 to view online articles, view products and/or services available through online retailers, and so forth. Of course, these are illustrative examples and claimed subject matter is not intended to be limited to illustrations. Continuing, at block 215, demand-side platform 2 may generate and/or provide one or more cookies, such as a cookie comprising, for example, signal samples having values of “abcd,” for example. At block 220, browser 1 may receive and store the one or more cookies from demand-side platform 2.

At block 225, demand-side platform 1 may query the computing device executing browser 1 and as a result obtain, for example, a plurality of cookies stored in memory, for example, of the computing device (and/or representations thereof). It should be noted that although block 225 shows receipt of two cookies, such as “1234” and “abcd,” in other embodiments, demand-side platform 1 may receive dozens, hundreds, thousands, or an even greater number of cookies (and/or representations thereof), such as from a browser 1 and/or from others. Thus, claimed subject matter is not limited to any particular number of cookies shown in an illustration, for example. Likewise, at block 230, demand-side platform 2 may query the computing device executing browser 1 and as a result obtain, for example, a plurality of cookies, again, stored in memory, for example. Again, although FIG. 2 shows receipt of two cookies, such as “abcd” and “1234,”claimed subject matter is intended to embrace receipt of dozens, hundreds, thousands, or a greater number of cookies, for example.

At block 235, demand-side platform 1 may generate one or more cookie maps, which may provide a correspondence among one or more cookies obtained from browser 1. For example, demand-side platform 1 may obtain a previously provided cookie, such as “1234,” generated and/or provided at block 205. In an embodiment, also at block 235, demand-side platform 1 may recognize cookie “abcd,” in the form of an identifier comprising signal samples, for example, as being generated by, for example, demand-side platform 2. Block 235 may also involve recognizing additional cookies, in the form of identifiers comprising signal samples, for example, as being generated and/or provided by other demand-side platforms not shown in FIG. 2.

Likewise, at block 240, demand-side platform 2 may generate one or more cookie maps, which may provide a correspondence among one or more cookies obtained from browser 1. For example, demand-side platform 2 may obtain a previously provided cookie, such as “abcd,” generated and/or provided at block 215. In an embodiment, also at block 240, demand-side platform 2 may recognize a cookie “1234” as being generated by, for example, demand-side platform 1. Block 240 may involve recognizing additional cookies as being generated and/or provided by other demand-side platforms not shown in FIG. 2.

At block 245, browser 1 may churn one or more cookies, such as may be stored in a cookie folder, for example, which may bring about deletion of one or more cookies provided by demand-side platform 1, such as the cookie provided at block 205. As mentioned previously, cookies may be periodically and/or occasionally churned for a variety of possible reasons, including, for example, autonomous, device-initiated processes, such as disk cleanup and/or detection of cache overflow. Alternatively, as another example, churn may be brought about by a browser limiting a number of cookies that correspond to a particular domain (e.g., Internet domain). Accordingly, at block 245, demand-side platform 1 may generate and/or provide a new cookie, for example, in the form of signal samples having values of “2345.” At block 250, a cookie provided at block 247 may be stored as physical states in memory of the computing device executing browser 1. Thus, cookie “2345” may be provided responsive to the user in this example operating browser 1 to view articles, products and/or services from online retailers, etc.

At block 255, demand-side platform 2 may obtain one or more stored cookies, such as stored in memory of the computing device executing browser 1. At block 260, responsive to recognizing cookie “abcd” as having been previously provided to browser 1, such as at block 215, demand-side platform 2 may establish correspondence between a cookie comprising signal samples having values “abcd” with a cookie provided by demand-side platform 1, such as “2345.” Thus, at block 260, demand-side platform 2 may generate a cookie map and/or update a cookie map just generated or previously generated. At block 265, perhaps, but not necessarily, in response to accessing a recently or newly-generated cookie (such as a cookie comprising signal samples having values “2345,” for example), demand-side platform 1 may determine that a user corresponding to cookie “2345” does not appear to comprise a user for whom a significant amount of browsing history appears to have been collected and/or be available. Accordingly, demand-side platform 1 may query, such as at block 265, demand-side platform 2 to obtain a cookie map. At block 270, demand-side platform 2 may supply a cookie map, as requested.

At block 275, demand-side platform 1 may evaluate a received cookie map, such as from demand-side platform 2 in this example. Demand-side platform 1 may initiate an evaluation, for example, responsive to receipt of a notification from a real-time bidding system; however, an evaluation may be initiated without a notification. Nonetheless, notification may indicate that a real-time bidding system, such as real-time bidding system 120 of FIG. 1, will initiate a real-time bidding auction. An evaluation, such as illustrated by 275, may indicate, for example, that a cookie comprising signal samples having values, such as “abcd,” corresponds to an entry of a previously-generated cookie map, such as a cookie map generated at block 235. Thus, for example, an evaluation by demand-side platform 1 may establish correspondence between a cookie received from demand-side platform 2 (e.g., “abcd”) with a recently and/or newly-generated and provided cookie (e.g., “2345”). At block 285, for example, demand-side platform 1 may establish a correspondence between or among cookie “2345” (such as from block 247) and cookie “1234” (such as from block 235).

Thus, as illustrated by the method embodiment of FIG. 2, if a cookie, such as provided and/or generated by a demand-side platform, such as 1, as an example, is churned, such as by browser 1, for example, a first demand-side platform may query a second demand-side platform, for example. Thus, as shown by a non-limiting illustration, a demand-side platform, such as 1, may determine a correspondence of cookies, so that, despite a cookie having been churned (e.g., replaced), a more accurate bid may be estimated. Thus, in this illustrative example, a demand-side platform may transmit an estimate bid with improved accuracy and, therefore, is more likely to be selected by a real-time bidding system, such as real-time bidding system 120 of FIG. 1.

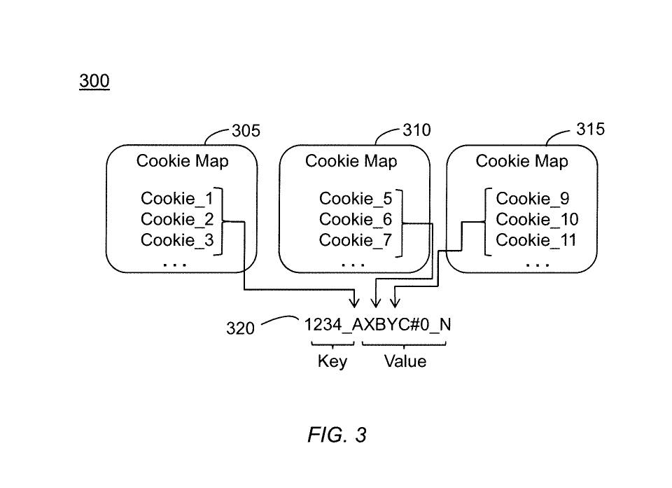

FIG. 3 is a schematic diagram showing multiple cookie maps and cookie mapping to a master key according to an embodiment 300. In an embodiment, such as shown in FIG. 3, cookie maps 305, 310, and 315 may comprise separate maps, such as described with reference to blocks 235 and/or 240 of FIG. 2. Accordingly, cookie_1, cookie_2, and cookie_3 may comprise, for example, cookies generated and/or provided by demand-side platforms for different media networks, for example. Cookie_2 may comprise a cookie generated and/or provided by a first demand-side platform, and cookie_3 may comprise a cookie generated and/or provided by a second demand-side platform. It should be noted, that cookie maps 305, 310, and 315 may comprise cookies from any number of demand-side platforms, and claimed subject matter is not limited in this respect. Likewise, cookie_5, cookie_6, cookie_7, cookie_9, cookie_10, and cookie_11 may also comprise cookies generated and/or provided by a large number of additional demand-side platforms not shown in FIG. 3. Further, although cookie maps 305, 310, and 315 indicate three cookies per cookie map in this example, claimed subject matter is intended to embrace cookie maps containing any number of cookies, such as dozens of cookies, hundreds of cookies, and so forth.

In accordance with FIG. 3, key/value pair 320 illustrates an example of an approach employing a master key to associate cookies from multiple cookie maps, for example. In an embodiment, such as shown in FIG. 3, key/value pair 320 may comprise signal samples having values comprising alphanumeric values. In this example, a first portion comprises a key, such as, for example, signal samples having values comprising a user ID and e-mail address (e.g., a relatively consistent identifier). A latter portion of key/value pair 320 may comprise, for example, signal samples having values that may vary by map, for example. Thus, key/value pair 320 may comprise alphanumeric characters “1234_AXBYC#0_N” for cookie map 305.

However, key/value pair 320 may comprise alphanumeric characters “1234_VXCYJ#9_R for cookie map 310. It should be noted that the preceding master key examples are meant to comprise simple examples. However, claimed subject matter is intended to embrace any and all configurations and/or arrangements of master keys virtually without limitation.

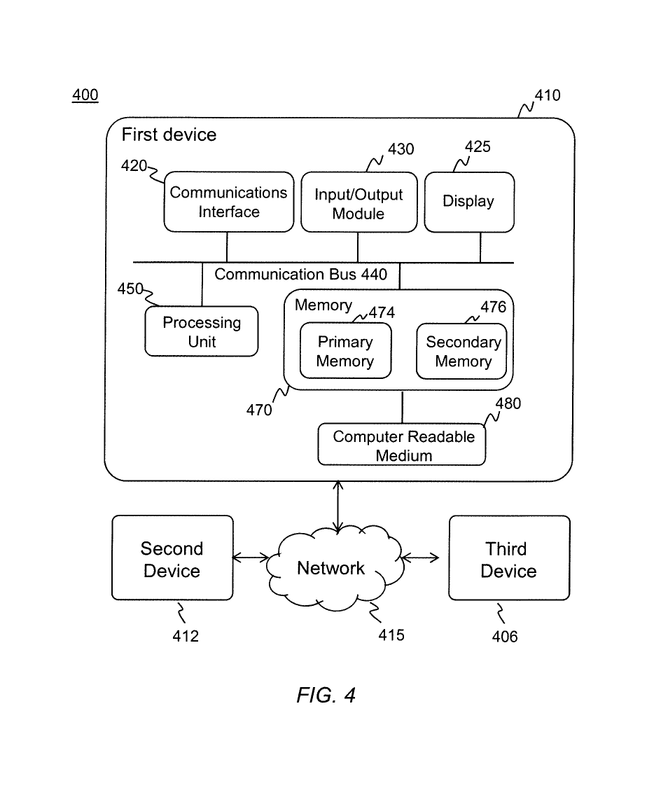

For purposes of illustration, FIG. 4 is an illustration of an embodiment of a system 400 that may be employed in a client-server type interaction, such as described infra. In connection with rendering a graphical user interface via a device, such as a network device and/or a computing device, for example. In FIG. 4, computing device 410 (‘first device’ in figure) may interface with client 412 (‘second device’ in figure), which may comprise features of a client computing device, for example. Communications interface 420, processor (e.g., processing unit) 450, and memory 470, which may comprise primary memory 474 and secondary memory 476, may communicate by way of communication bus 440, for example. In FIG. 1, client computing device 412 may represent one or more sources of analog, uncompressed digital, lossless compressed digital, and/or lossy compressed digital formats for content of various types, such as video, imaging, text, audio, etc. in the form physical states and/or signals, for example. Client computing device 412 may communicate with computing device 410 by way of a connection, such as an internet connection, via network 415, for example. Although computing device 410 of FIG. 4 shows the above-identified components, claimed subject matter is not limited to computing devices having only these components as other implementations may include alternative arrangements that may comprise additional components or fewer components, such as components that function differently while achieving similar results. Rather, examples are provided merely as illustrations. It is not intended that claimed subject matter to limited in scope to illustrative examples.

Processing unit 450 may be representative of one or more circuits, such as digital circuits, to perform at least a portion of a computing procedure and/or process. By way of example, but not limitation, processing unit 450 may comprise one or more processors, such as controllers, microprocessors, microcontrollers, application specific integrated circuits, digital signal processors, programmable logic devices, field programmable gate arrays, the like, or any combination thereof. In implementations, processing unit 450 may perform signal processing to manipulate signals and/or states, to construct signals and/or states, etc., for example.

Memory 470 may be representative of any storage mechanism. Memory 470 may comprise, for example, primary memory 474 and secondary memory 476, additional memory circuits, mechanisms, or combinations thereof may be used. Memory 470 may comprise, for example, random access memory, read only memory, etc., such as in the form of one or more storage devices and/or systems, such as, for example, a disk drive, an optical disc drive, a tape drive, a solid-state memory drive, etc., just to name a few examples. Memory 470 may be utilized to store a program. Memory 470 may also comprise a memory controller for accessing computer readable-medium 480 that may carry and/or make accessible content, which may include code, and/or instructions, for example, executable by processing unit 450 and/or some other unit, such as a controller and/or processor, capable of executing instructions, for example.

Under direction of processing unit 450, memory, such as memory cells storing physical states, representing, for example, a program, may be executed by processing unit 450 and generated signals may be transmitted via the Internet, for example. Processing unit 450 may also receive digitally-encoded signals from client computing device 412.

Network 415 may comprise one or more network communication links, processes, services, applications and/or resources to support exchanging communication signals between a client computing device, such as 412, and computing device 406 (‘third device’ in figure), which may, for example, comprise one or more servers (not shown). By way of example, but not limitation, network 415 may comprise wireless and/or wired communication links, telephone and/or telecommunications systems, Wi-Fi networks, Wi-MAX networks, the Internet, a local area network (LAN), a wide area network (WAN), or any combinations thereof.

The term “computing device,” as used herein, refers to a system and/or a device, such as a computing apparatus, that includes a capability to process (e.g., perform computations) and/or store content, such as measurements, text, images, video, audio, etc. in the form of signals and/or states. Thus, a computing device, in this context, may comprise hardware, software, firmware, or any combination thereof (other than software per se). Computing device 410, as depicted in FIG. 1, is merely one example, and claimed subject matter is not limited in scope to this particular example. For one or more embodiments, a computing device may comprise any of a wide range of digital electronic devices, including, but not limited to, personal desktop and/or notebook computers, high-definition televisions, digital versatile disc (DVD) players and/or recorders, game consoles, satellite television receivers, cellular telephones, wearable devices, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 470 may store cookies relating to one or more users and may also comprise a computer-readable medium that may carry and/or make accessible content, including code and/or instructions, for example, executable by processing unit 450 and/or some other unit, such as a controller and/or processor, capable of executing instructions, for example. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

Regarding aspects related to a communications and/or computing network, a wireless network may couple client devices with a network. A wireless network may employ stand-alone ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including Long Term Evolution (LTE), WLAN, Wireless Router (WR) mesh, 2nd, 3rd, or 4th generation (2G, 3G, or 4G) cellular technology and/or the like. Network access technologies may enable wide area coverage for devices, such as client devices with varying degrees of mobility, for example.

A network may enable radio frequency and/or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device or a computing device, between or within a network, or the like.

Communications between a computing device and/or a network device and a wireless network may be in accordance with known and/or to be developed communication network protocols including, for example, global system for mobile communications (GSM), enhanced data rate for GSM evolution (EDGE), 802.11b/g/n, and/or worldwide interoperability for microwave access (WiMAX). A computing device and/or a networking device may also have a subscriber identity module (SIM) card, which, for example, may comprise a detachable smart card that is able to store subscription content of a user, and/or is also able to store a contact list of the user. A user may own the computing device and/or networking device or may otherwise be a user, such as a primary user, for example. A computing device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a communication network may be embodied as a wired network, wireless network, or any combinations thereof.

A device, such as a computing and/or networking device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

A computing and/or network device may include and/or may execute a variety of now known and/or to be developed operating systems, derivatives and/or versions thereof, including personal computer operating systems, such as a Windows, iOS, Linux, a mobile operating system, such as iOS, Android, Windows Mobile, and/or the like. A computing device and/or network device may include and/or may execute a variety of possible applications, such as a client software application enabling communication with other devices, such as communicating one or more messages, such as via protocols suitable for transmission of email, short message service (SMS), and/or multimedia message service (MMS), including via a network, such as a social network including, but not limited to, Facebook, LinkedIn, Twitter, Flickr, and/or Google+, to provide only a few examples. A computing and/or network device may also include and/or execute a software application to communicate content, such as, for example, textual content, multimedia content, and/or the like. A computing and/or network device may also include and/or execute a software application to perform a variety of possible tasks, such as browsing, searching, playing various forms of content, including locally stored and/or streamed video, and/or games such as, but not limited to, fantasy sports leagues. The foregoing is provided merely to illustrate that claimed subject matter is intended to include a wide range of possible features and/or capabilities.

A network may also be extended to another device communicating as part of another network, such as via a virtual private network (VPN). To support a VPN, broadcast domain signal transmissions may be forwarded to the VPN device via another network. For example, a software tunnel may be created between a logical broadcast domain, and a VPN device. Tunneled traffic may, or may not be encrypted, and a tunneling protocol may be substantially compliant with and/or substantially compatible with any now known and/or to be developed versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, another existing protocol, and/or another protocol that may be developed.

A virtual private network (VPN) may enable a remote device to more securely (e.g., more privately) communicate via a local network. A router may allow network communications in the form of network transmissions (e.g., signal packets and/or frames), for example, to occur from a remote device to a VPN server on a local network. A remote device may be authenticated and a VPN server, for example, may create a special route between a local network and the remote device through an intervening router. However, a route may be generated and/or also regenerate if the remote device is power cycled, for example. Also, a VPN typically may affect a single remote device, for example, in some situations.

Typically, a network protocol, such as protocols characterized substantially in accordance with the aforementioned OSI model, has several layers. These layers may be referred to here as a network stack. Various types of network transmissions may occur across various layers. A lowest level layer in a network stack, such as the so-called physical layer, may characterize how symbols (e.g., bits and/or bytes) are transmitted as one or more signals over a physical medium (e.g., twisted pair copper wire, coaxial cable, fiber optic cable, wireless air interface, combinations thereof, etc.). Progressing to higher-level layers in a network protocol stack, additional operations may be available by initiating network transmissions that are compatible and/or compliant with a particular network protocol at these higher-level layers. Therefore, for example, a hardware bridge, by itself, may be unable to forward signal packets to a destination device since transmission of signal packets characterized at a higher-layer of a network stack may not be supported by a hardware bridge. Although higher-level layers of a network protocol may, for example, affect device permissions, user permissions, etc., a hardware bridge, for example, may typically provide little user control, such as for higher-level layer operations.

It will, of course, be understood that, although particular embodiments will be described, claimed subject matter is not limited in scope to a particular embodiment and/or implementation. For example, one embodiment may be in hardware, such as implemented to operate on a device or combination of devices, for example, whereas another embodiment may be, at least in part, in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms, and/or symbolic representations of operations on binary signals and/or states, such as stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining,” “establishing,” “obtaining,” “identifying,” “selecting,” “generating,” and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
processing multiple cookies for a particular user;
determining a correspondence between at least two separate cookies of the multiple cookies for the particular user, at least one of the at least two separate cookies comprises an unusable cookie; and
recovering a cookie for the unusable cookie based at least in part on the determination, the recovered cookie comprising a cookie for the particular user.

2. The method of claim 1, wherein the multiple cookies comprise one or more cookie maps

3. The method of claim 2, further comprising:
updating the one or more cookie maps to include a newly-generated cookie for the particular user.

4. The method of claim 2, wherein the one or more cookie maps comprise at least two cookie maps, and wherein the at least two cookie maps are generated by separate demand-side platforms.

5. The method of claim 4, further comprising:
generating a master key for inclusion in the at least two cookie maps, the master key to associate different cookies across different cookie maps in which the different cookies across the different maps are cookies for the particular user.

6. The method of claim 1, further comprising:
accessing stored user interactions based at least in part on there covered cookie.

7. The method of claim 6, further comprising:
accessing a database to determine other attributes of the particular user.

8. The method of claim 6, further comprising:
generating a bid for a real-time bidding (RTB) auction in which auctioning of one or more advertisements for display to one or more users takes place, the generated bid comprising a bid for displaying the one or more advertisements to the particular user.

9. The method of claim 8, further comprising:
transmitting the generated bid to a real-time bidding system that executes the RTB auction.

10. An apparatus comprising: a computing device; the computing device to process multiple cookies for a particular user, to determine a correspondence between at least two separate cookies of the multiple cookies for the particular user, at least one of the at least two separate cookies to comprise an unusable cookie, and to recover a cookie for the unusable cookie based at least in part on the determination, the cookie to be recovered to comprise a cookie for the particular user.

11. The apparatus of claim 10, wherein the multiple cookies are to comprise one or more cookie maps.

12. The apparatus of claim 11, wherein the one or more cookie maps are to comprise at least two cookie maps having been generated by separate demand-side platforms.

13. The apparatus of claim 12, wherein the computing device to further generate a master key for inclusion in the at least two cookie maps, the master key to associate different cookies across different cookie maps in which the different cookies across the different maps to comprise cookies for the particular user.

14. The apparatus of claim 13, wherein the computing device to further generate a bid for a real-time bidding (RTB) auction in which auctioning of one or more advertisements for display to one or more users is to take place, the bid to be generated to comprise a bid for displaying one or more advertisements to the particular user.

15. An article comprising: a non-transitory storage medium having stored thereon instructions executable by a computing device to process multiple cookies for a particular user, to determine a correspondence between at least two separate cookies of the multiple cookies for the particular user, at least one of the at least two separate cookies to comprise an unusable cookie, and to recover a cookie for the unusable cookie based at least in part on the determination, the cookie to be recovered to comprise a cookie for the particular user.

16. The article claim 15, wherein the multiple cookies are to comprise one or more cookie maps.

17. The article of claim 16, wherein the computing device further to update the one or more cookie maps to include newly-generated cookie for the particular user

18. The article of claim 16, wherein the one or more cookie maps are to comprise at least two cookie maps having been generated by separate demand-side platforms.

19. The article of claim 18, wherein the computing device to further generate a master key for inclusion in the at least two cookie maps, the master key to associate different cookies across different cookie maps in which the different cookies across the different maps to comprise cookies for the particular user.

20. The article of claim 15, wherein the computing device to further generate a bid for a real-time bidding (RTB) auction in which auctioning of one or more advertisements for display to one or more users is to take place, the bid to be generated to comprise a bid for displaying the one or more advertisements to the particular user.
